(19) United States
(12) Patent Application Publication
(10) Pub. No.: US 2019/0310818 A1
(43) Pub. Date: Oct. 10, 2019

(54) SELECTIVE EXECUTION OF WARPING FOR GRAPHICS PROCESSING

(71) Applicant: QUALCOMM Incorporated, San Diego, CA (US)

(72) Inventors: Jun Liu, Irvine, CA (US); Tao Shen, San Diego, CA (US); Wenbiao Wang, San Diego, CA (US); Aravind Bhaskara, San Diego, CA (US); Mohit Hari Bhave, San Diego, CA (US); Nishant Hariharan, San Diego, CA (US); Taiyuan Fang, San Diego, CA (US); Rong Li, San Diego, CA (US)

(21) Appl. No.: 15/947,396

(22) Filed: Apr. 6, 2018

(51) Int. Cl. G06F 3/14; G06T 7/00; G06T 1/20; G06T 1/60; G06T 5/00

(52) U.S. Cl. CPC G06F 3/1415; G06T 7/001; G06T 5/001; G06T 1/60; G06T 1/20

(57) ABSTRACT

Example techniques are described for image processing to selectively perform a warping operation if there is change in orientation of a display device between frames. For example, if there is change in orientation of a display device between processing a first frame and after rendering of a second frame, processing circuitry may perform a warp operation on the second frame to warp image content of the second frame based on a current orientation of the display device. If there is no change in orientation of the display device between processing a third frame and after rendering of a fourth frame, the processing circuitry may bypass the warp operation on the fourth frame to avoid warping entire image content of the fourth frame.

### TECHNICAL FIELD

The disclosure relates to processing of image content information and, more particularly, warping of image content information for output to a display.

### BACKGROUND

Split-rendered systems may include at least one host device and at least one client device that communicate over a network (e.g., a wireless network, wired network, etc.). For example, a Wi-Fi Direct (WFD) system includes multiple devices communicating over a Wi-Fi network. The host device acts as a wireless access point and sends image content information, which may include audiovisual (AV) data, audio data, and/or video data, to one or more client devices participating in a particular peer-to-peer (P2P) group communication session using one or more wireless communication standards, e.g., IEEE 802.11. The image content information may be played back at the client devices. More specifically, each of the participating client devices processes the received image content information for presentation on a local display screen and audio equipment. In addition, the host device may perform at least some processing of the image content information for presentation on the client devices.

The host device and one or more of the client devices may be either wireless devices or wired devices with wireless communication capabilities. In one example, as wired devices, one or more of the host device and the client devices may include televisions, monitors, projectors, set-top boxes, DVD or Blu-Ray Disc players, digital video recorders, laptop or desktop personal computers, video game consoles, and the like, that include wireless communication capabilities. In another example, as wireless devices, one or more of the host device and the client devices may include mobile telephones, portable computers with wireless communication cards, personal digital assistants (PDAs), portable media players, or other flash memory devices with wireless communication capabilities, including so-called “smart” phones and “smart” pads or tablets, or other types of wireless communication devices (WCDs).

In some examples, at least one of the client devices may be a display device. A display device may be any type of wired or wireless display device that is worn on a user's body. As an example, the display device may be a wireless head-worn display or wireless head-mounted display (WHMD) that is worn on a user's head in order to position one or more display screens in front of the user's eyes. The host device is typically responsible for performing at least some processing of the image content information for display on the display device. The display device is typically responsible for preparing the image content information for display at the display device.

### SUMMARY

In general, this disclosure relates to techniques for selectively performing a warp operation on image content based on whether there is change in orientation of a display device. Warping is an operation to use image content from a rendered frame, and warp that image content to a new location based on a current orientation of the display device. However, warping may be computationally intensive, and therefore, consume relatively large amounts of power and resources. In one or more examples, circuitry executes the warping operation if the orientation of the display device changes frame-to-frame. If the orientation of the display device does not change frame-to-frame, the circuitry may bypass the warp operation.

In one example, this disclosure describes a method of image processing, the method comprising determining, with one or more processors, that there is change in orientation of a display device between processing a first frame and after rendering a second frame, responsive to the determination that there was change in the orientation between processing the first frame and after rendering the second frame, performing, with the one or more processors, a warp operation on the second frame to warp image content of the second frame based on a current orientation of the display device after rendering the second frame, determining, with the one or more processors, that there is no change in orientation of the display device between processing a third frame and after rendering of a fourth frame, and responsive to the determination that there is no change in the orientation of the display device between processing the third frame and after rendering the fourth frame, bypassing a warp operation on the fourth frame to avoid warping entire image content of the fourth frame.

In one example, this disclosure describes a device for image processing, the device comprising memory configured to store information indicative of orientation of the display device, and processing circuitry. The processing circuitry is configured to determine, based on the stored information, that there is change in orientation of a display device between processing a first frame and after rendering a second frame, responsive to the determination that there was change in the orientation between processing the first frame and after rendering the second frame, perform a warp operation on the second frame to warp image content of the second frame based on a current orientation of the display device after rendering the second frame, determine, based on the stored information, that there is no change in orientation of a display device between processing a third frame and after rendering of a fourth frame, and responsive to the determination that there is no change in the orientation of the display device between processing the third frame and after rendering the fourth frame, bypass a warp operation on the fourth frame to avoid warping entire image content of the fourth frame.

In one example, this disclosure describes a computer-readable storage medium storing instructions thereon that when executed cause one or more processors to determine that there is change in orientation of the display device between processing a first frame and after rendering a second frame, responsive to the determination that there was change in the orientation between processing the first frame and after rendering the second frame, perform a warp operation on the second frame to warp image content of the second frame based on a current orientation of the display device after rendering the second frame, determine that there is no change in orientation of the display device between processing a third frame and after rendering of a fourth frame, and responsive to the determination that there is no change in the orientation of the display device between processing the third frame and after rendering the fourth frame, bypass a warp operation on the fourth frame to avoid warping entire image content of the fourth frame.

The details of one or more examples of the disclosure are set forth in the accompanying drawings and the description below. Other features, objects, and advantages will be apparent from the description, drawings, and claims.

### BRIEF DESCRIPTION OF DRAWINGS

FIG. 1 is a block diagram illustrating a split-rendered system including a host device and a display device.

FIG. 2 is a block diagram illustrating the host device and display device from FIG. 1 in greater detail.

FIG. 3 is a block diagram illustrating an example of the multimedia processor, memory, and display panel of FIG. 2 in greater detail.

FIG. 4 is a flowchart illustrating an example method of image processing in accordance with one or more examples described in this disclosure.

FIG. 5 is a flowchart illustrating an example method of image processing when there is no change in display device orientation, in accordance with one or more examples described in this disclosure.

FIG. 6 is a flowchart illustrating an example method of image processing when there is change in display device orientation, in accordance with one or more examples described in this disclosure.

FIG. 7 is a flowchart illustrating an example method of image processing when there is no change in display device orientation and change in image content between current frame and previous frame, in accordance with one or more examples described in this disclosure.

### DETAILED DESCRIPTION

Imaging systems may generate a 360-degree image (e.g., canvas) for displaying video. For example, an imaging system may output a portion of the canvas that is in a user's field of view at a virtual reality or augmented reality headset.

Some imaging systems may be split-rendered. An example split-rendered system may include a host device (e.g., computer, cloud, etc.) that generates a compressed rendered video stored in a buffer. For example, the buffer can store video data, audiovisual data, and/or audio data for the video. The split-rendered system also includes a client device (e.g., a display device) that decompresses the compressed rendered video (e.g., reconstructs the video data, audiovisual data, and/or audio data) for display at the client device.

In virtual reality (VR) or augmented reality (AR) applications, a user interacts with a display device, such as a wearable display device, that includes processing circuitry to receive, decode, process, and display image content. The image content that the display device receives is based on the orientation information or pose information (e.g., pitch, roll, and yaw) of the display device. For instance, the display device sends orientation information to a server (e.g., host device) relatively frequently (e.g., 30 times per second). The server, based on the orientation information, encodes and transmits image content that would be viewable from the particular orientation of the display device.

Circuitry on the display device (e.g., a central processing unit (CPU), a graphics processing unit (GPU), etc.) receives the image content and reconstructs the image content to generate a frame. The circuitry may repeat such operations to generate frames, which form the video that is displayed. One example of processing that the circuitry performs is a warping operation to reconstruct the image content for frame generation. Warping is an operation that can use image content from a frame, and render that image content to a different location based on a current orientation of the display device.

For example, the server generates image content based on display device orientation at the time the display device requested image content. However, by the time display device receives the image content, the user may have changed the orientation of the display device. There is delay from when the request for image content is transmitted, to when the image content is received. There can be change in the orientation of the display device during this delay.

If the image content, as received, is displayed, the displayed image content is relative to a previous display device orientation, and not a current display device orientation. In such cases, user experience may suffer because the display image content is not relative to the current display device orientation.

Warping warps the received image content based on the current orientation of the display device to compensate for the change in the orientation. For example, the GPU renders the image content as received, and then the GPU warps the rendered image content based on the current wearable display orientation. However, warping tends to consume a relatively large amount of power and requires operation at a high frequency (e.g., rendering at 120 frames per second).

This disclosure describes selective use of warping techniques based on a determination of whether there was a change in the orientation of the display device between frames generated by the GPU. If there is change in the orientation, the GPU may perform warping techniques. However, if there is no change in the orientation, the GPU may bypass a warping technique to avoid warping entire image content of a frame. If there is no change in the orientation between frame, but there is change in image content between frames, the GPU may update portions of the frame that changed, rather than updating the entire image content.

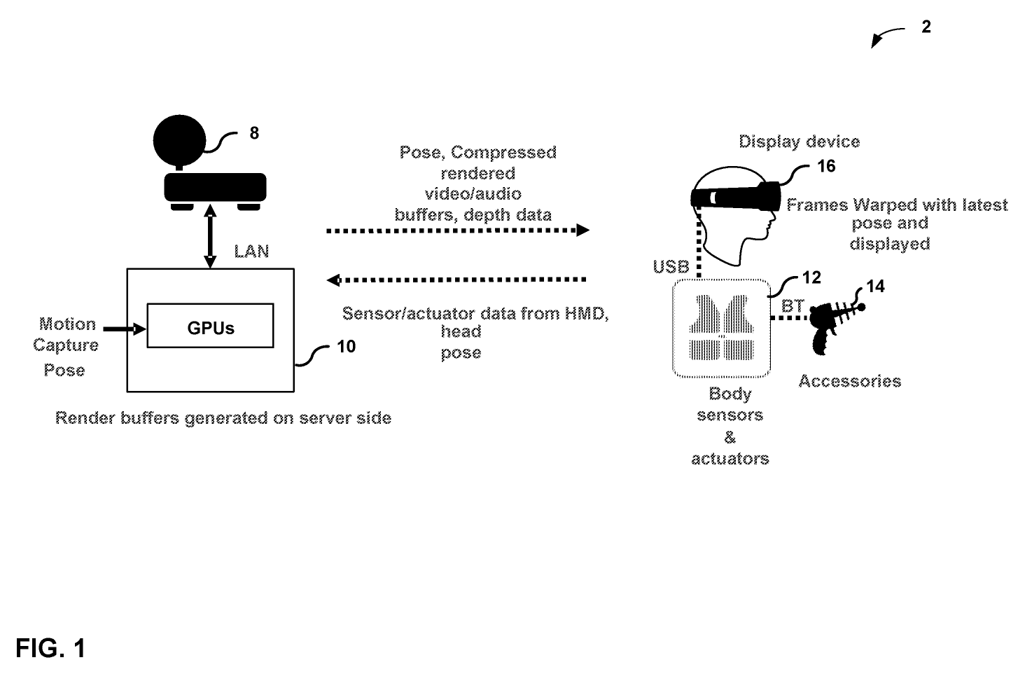

FIG. 1 is a block diagram illustrating split-rendered system 2 including a host device 10 and display device 16. In the example of FIG. 1, split-rendered system 2 includes host device 10 and only one client device, i.e., display device 16. In other examples, split-rendered system 2 may include additional client devices (not shown), which may be display devices, wireless devices or wired devices with wireless communication capabilities.

In some examples, split-rendered system 2 may conform to the Wi-Fi Direct (WFD) standard defined by the Wi-Fi Alliance. The WFD standard enables device-to-device communication over Wi-Fi networks, e.g., wireless local area networks, in which the devices negotiate their roles as either access points or client devices. Split-rendered system 2 may include one or more base stations (not shown) that support wireless networks over which a peer-to-peer (P2P) group communication session may be established between host device 10, display device 16, and other participating client devices. A communication service provider or other entity may centrally operate and administer one or more of these wireless networks using a base station as a network hub.

According to the WFD standard, host device 10 may act as a wireless access point and receive a request from display device 16 to establish a P2P group communication session. For example, host device 10 may establish the P2P group communication session between host device 10 and display device 16 using the Real-Time Streaming Protocol (RTSP). The P2P group communication session may be established over a wireless network, such as a Wi-Fi network that uses a wireless communication standard, e.g., IEEE 802.11a, 802.11g, or 802.11n improvements to previous 802.11 standards.

Once the P2P group communication session is established, host device 10 may send image content information, which may include audio video (AV) data, audio data, and/or video data, to display device 16, and any other client devices, participating in the particular P2P group communication session. For example, host device 10 may send the image content information to display device 16 using the Real-time Transport protocol (RTP). The image content information may be played back at a display panel of display device 16, and possibly at host device 10 as well. It should be understood that display of content at host device 10 is merely one example, and is not necessary in all examples.

For instance, in a gaming application, such as a VR or AR application, host device 10 may be a server receiving information from each of multiple users, each wearing an example display device 16. Host device 10 may selectively transmit different image content to each one of the devices like display device 16 based on the information that host device 10 receives. In such examples, there may be no need for host device 10 to display any image content.

Display device 16 may process the image content information received from host device 10 for presentation on the display panel of display device 16 and audio equipment. Display device 16 may perform these operations with a central processing unit (CPU) (also referred to as a controller) and GPU that are limited by size and weight in order to fit within the structure of a handheld device. In addition, host device 10 may perform at least some processing of the image content information for presentation on display device 16.

A user of display device 16 may provide user input via an interface, such as a human interface device (HID), included within or connected to display device 16. An HID may be one or more of a touch display, an input device sensitive to an input object (e.g., a finger, stylus, etc.), a keyboard, a tracking ball, a mouse, a joystick, a remote control, a microphone, or the like. As shown, display device 16 may be connected to one or more body sensors and actuators 12 via universal serial bus (USB), and body sensors and actuators 12 may be connected to one or more accessories 14 via Bluetooth™.

Display device 16 sends the provided user input to host device 10. In some examples, display device 16 sends the user input over a reverse channel architecture referred to as a user input back channel (UIBC). In this way, host device 10 may respond to the user input provided at display device 16. For example, host device 10 may process the received user input and apply any effect of the user input on subsequent data sent to display device 16.

Host device 10 may be, for example, a wireless device or a wired device with wireless communication capabilities. In one example, as a wired device, host device 10 may be one of a television, monitor, projector, set-top box, DVD or Blu-ray™ Disc player, digital video recorder, laptop or desktop personal computer, video game console, and the like, that includes wireless communication capabilities. Other examples of host device 10 are possible.

For example, host device 10 may be a file server that stores image content, and selectively outputs image content based on user input from display device 16. For instance, host device 10 may store 360-degree video content and, based on user input, may output selected portions of the 360-degree video content. In some examples, the selected portions of the 360-degree video content may be pre-generated and pre-stored video content. In some examples, host device 10 may generate the image content on-the-fly using the GPUs of host device 10. In examples where host device 10 transmits pre-stored video content, host device 10 need not necessarily include the GPUs. Host device 10 may be proximate to display device 16 (e.g., in the same room), or host device 10 and display device 16 may be in different locations (e.g., separate rooms, different parts of a country, different parts of the world, etc.).

As shown, host device 10 may be connected to a router 8 and can connect to the Internet via a local area network (LAN). In another example, as a wireless device, host device 10 may be one of a mobile telephone, portable computer with a wireless communication card, personal digital assistant (PDA), portable media player, or other flash memory device with wireless communication capabilities, including a so-called “smart” phone or “smart” pad or tablet, or another type of wireless communication device (WCD).

Display device 16 may be any type of wired or wireless display device. As an example, display device 16 may be a head-worn display or a head-mounted display (HMD) that is worn on a user's head in order to position one or more display screens in front of the user's eyes. In general, the display screens of display device 16 may be one of a variety of display screens such as a liquid crystal display (LCD), a plasma display, an organic light emitting diode (OLED) display, or another type of display screen.

Although one or more examples are described with respect to display device 16 being an HMD device, the techniques are not so limited. Display device 16 may be a device the user holds or interacts with otherwise. Display device 16 may be a device whose orientation changes based on user movement or user instructions, and one non-limiting example of such a device is a wearable display device such as an HMD device.

In one example, display device 16 may be a HMD device formed as glasses that include display screens in one or more of the eye lenses, and also include a nose bridge and temple arms to be worn on a user's face. As another example, display device 16 may be a device formed as goggles that includes display screens in separate eye lenses or a single display screen, and that also includes at least one strap to hold the goggles on the user's head. Although display device 16 is described in this disclosure as being a HMD, in other examples display device 16 may be display devices that are worn on other portions of the user's body, such as on the user's neck, shoulders, arm or wrist, or are handheld devices.

In the example of FIG. 1, display device 16 outputs sensor and/or actuator data to host device 10. The sensor and/or actuator data may include eye pose data indicating a user's field of view and/or orientation of display device 16. In response to receiving the sensor and/or actuator data, host device 10 generates image content information for rendering a frame. For example, host device 10 may generate a compressed video and audio data using eye and device orientation data indicated by the sensor and/or actuator data.

A processor (e.g., a CPU, a GPU, etc.) of display device 16 renders the image content to an eye buffer based on the image content received from host device 10. For example, the processor includes a graphics processing pipeline that receives as input instructions and image content information from host device 10. The processor then generates the image content based on the instructions and image content information, and stores the generated image content in the eye buffer. The eye buffer is referred to as such because it stores image content generated based on the position of the eye and the orientation of display device 16.

In some cases, by the time the processor completed rendering (e.g., generating and storing) the image content to the eye buffer, the orientation of display device 16 may have changed. As one example, the user may have moved his or her head in between the time when the processor received the instructions and the image content information from host device 10 and the time when the processor completed rendering the image content to the eye buffer. In this example, if the image content from the eye buffer is displayed, the user may experience disorientation because the image content is from a different orientation of display device 16 than the current orientation.

To account for the change in orientation of display device 16, the processor can perform an operation referred to as “warp.” In the warp operation, the processor warps the image content stored in the eye buffer to different locations within an image frame based on the current orientation of display device 16. Display device 16 then displays the warped image frame. In this case, the user may not experience disorientation because the warped image frame is based on the current orientation of display device 16. Examples of the warp operation include synchronous time warp (STW), STW with depth, asynchronous time warp (ATW), ATW with depth, asynchronous space warp (ASW), or ASW with depth.

The warp operation is useful for compensating changes in orientation of display device 16. However, the warp operation tends to be computationally expensive, and potentially requires the processor to operate at a high frequency. For example, without warping, the processor, on average, can render image content to the eye buffer at 24 frames per second (fps) to 30 fps. A display processor of display device 16 can refresh image content on a display panel at approximately 24 fps to 30 fps. Therefore, without warping, the processor can operate at approximately 30 to 60 hertz (Hz) to achieve the rendering rate of 24 to 30 fps. For example, for 30 fps, the processor may need to render a frame every 33.3 milliseconds (ms).

With warping, the processor may need to perform more operations that tend to be computationally expensive. Therefore, for the processor to perform warping, but still achieve rendering rate of 24 to 30 fps, the processor may operate at a higher frequency to complete the warping operations. For instance, the processor may need to operate at a higher frequency such that the processor is able to complete all warping operations within 33.3 ms to achieve 30 fps. As one example, the processor may operate at 120 Hz, rather than the 30 to 60 Hz to achieve the rendering rate of 24 to 30 fps.

Furthermore, the processor may receive orientation information of display device 16 every few clock cycles. In some examples, due to the high operating frequency, the GPU may receive orientation information for display device 16 more often than if the GPU were operating at a lower operating frequency. Accordingly, orientation of display device 16 is heavily oversampled (e.g., information of the orientation of display device 16 is determined more often) as compared to how often display device 16 outputs orientation information for receiving image content.

Operating at relatively high frequency can result in increased power consumption of the processor, which can be a technical problem. For example, the processor may consume more than 200 milliwatts (mW) of power for the warping operation. In some examples, to provide power for constant warping operations, display device 16 may use large amounts of power that can reduce battery life, increase energy costs, cause display device 16 to heat, and the like. This disclosure describes example techniques to solve such a technical problem by reducing the number of warping operations, and thereby improves the operation of display device 16.

As one example, the warping operation accounts for changes in the orientation of display device 16. However, if there is no change in orientation of display device 16, then the processor may bypass the warping operation to avoid warping entire image content of a frame, thereby saving power. There are types of content (e.g., in video games and wearable device video content) where a user may not change the orientation of display device 16. For instance, in some example content, there may be no change in the orientation of display device 16 between a previous frame and a current frame in approximately 77% of the frames. Hence, operational power may be wasted by performing warping operations on all frames because, in this example, for 77% of the frames, the warping operation may have provided limited or no benefit.

In one or more examples described in this disclosure, the processor (e.g., a controller, the GPU, or some other circuitry alone or in combination with the controller and/or GPU) may determine whether there is a change in an orientation of display device 16 from a previous frame to a current frame. If there is no change, the processor may bypass warping operation to avoid warping entire image content of a frame. If there is a change, the processor may perform the warping operation.

One example of the time between a previous frame and a current frame is the time from when the processor outputted a previous frame to when the processor completed rendering a current frame to the eye buffer. Another example of the time between a previous frame and a current frame is the time from when the processor rendered a previous frame to the eye buffer to when the processor rendered a current frame to the eye buffer. Another example of time between a previous frame and a current frame is the time from when the display processor updated a display panel (or memory of a display panel) with image content of a previous frame to when the processor completed rendering a current frame to the eye buffer. Another example of time between a previous frame and a current frame is the time from when display device 16 outputted orientation information for receiving image content for the previous frame to when display device 16 outputted orientation information for receiving image content for the current frame.

As one example, the processor may render image content for a previous frame to an eye buffer, and then perform warping on the previous frame based on the orientation of display device 16 to generate a warped previous frame for storage in a frame buffer. Then, the processor may render image content for a current frame to an eye buffer. In one example, the time between the previous frame and the current frame is the time between when the processor generated the warped previous frame to when the processor is determining whether to perform warping on the current frame stored in the eye buffer. If no warping was performed on the previous frame, then, in one example, the time between the previous frame and the current frame is the time between when the processor determined no warping is to be performed on the previous frame and when the processor is determining whether to perform warping on the current frame stored in the eye buffer.

By selectively bypassing the warping operation, the processor may conserve power. In some examples, to further conserve power, if the orientation of display device 16 did not change from a previous to a current frame, but if image content changed, the processor may perform limited updating (e.g., texture mapping rather than warping) on the changed portions in the previous frame rather than perform all operations (e.g., texture mapping) to generate the current frame. In this manner, the processor may further conserve power by limiting the number of operations that are performed. For example, response to a determination that there is change in the image content between a current frame and a previous frame and no change in the orientation of display device 16 between processing the previous frame and after rendering the current frame, the processor may update a portion, and not the entirety, of a frame buffer that stores image content for the previous frame based on the change between the previous frame and the current frame.

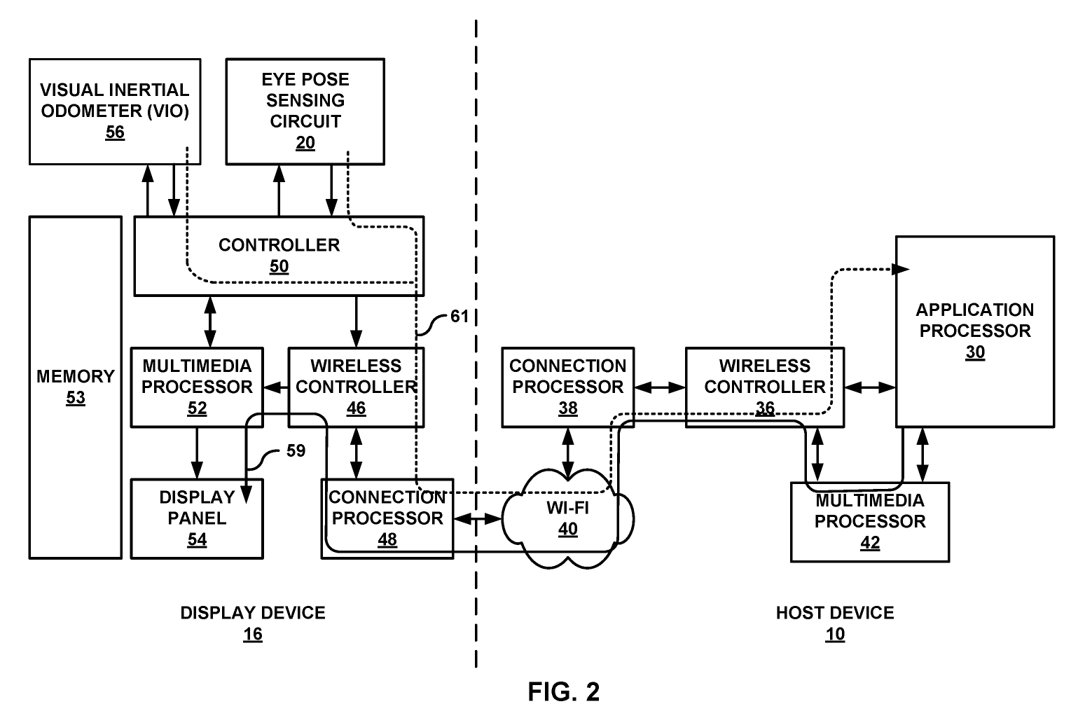

FIG. 2 is a block diagram illustrating host device 10 and display device 16 from FIG. 1 in greater detail. For purposes of this disclosure, host device 10 and display device 16 will primarily be described as being wireless devices. For example, host device 10 may be a server, a smart phone or smart pad, or other handheld WCD, and display device 16 may be a WHMD device. In other examples, however, host device 10 and display device 16 may be wireless devices or wired devices with wireless communication capabilities.

It should be understood that the various functions ascribed to controllers and processors of FIG. 2 are described merely as examples and should not be considered limiting. Host device 10 and display device 16 may include more or fewer controllers and processors than those illustrated. Also, the operations described with respect to one of the controllers or processors may be performed by another one of the controllers or processors or in combination with another one of the controllers or processors.

In the example illustrated in FIG. 2, host device 10 includes circuitry such as an application processor 30, a wireless controller 36, a connection processor 38, and a multimedia processor 42. Host device 10 may include additional circuitry used to control and perform operations described in this disclosure.

Application processor 30 may be a general-purpose or a special-purpose processor that controls operation of host device 10. As an example, application processor 30 may execute a software application based on a request from display device 16. In response, application processor 30 may generate image content information. An example of a software application that application processor 30 executes is a VR or AR application. Other examples also exist such as a video playback application, a media player application, a media editing application, a graphical user interface application, a teleconferencing application or another program. In some examples, a user may provide input to host device 10 via one or more input devices (not shown) such as a keyboard, a mouse, a microphone, a touch pad or another input device that is coupled to host device 10 to cause host device 10 to execute the application.

The software applications that execute on application processor 30 may include one or more graphics rendering instructions that instruct multimedia processor 42, which includes the GPU illustrated in FIG. 1, to cause the rendering of graphics data. In some examples, the software instructions may conform to a graphics application programming interface (API), such as, e.g., an Open Graphics Library (OpenGL®) API, an Open Graphics Library Embedded Systems (OpenGL® ES) API, a Direct3D API, an X3D API, a RenderMan™ API, a WebGL® API, or any other public or proprietary graphics API. In order to process the graphics rendering instructions, application processor 30 may issue one or more graphics rendering commands to multimedia processor 42 to cause multimedia processor 42 to perform some or all of the rendering of the graphics data. In some examples, the graphics data to be rendered may include a list of graphics primitives, e.g., points, lines, triangles, quadrilaterals, triangle strips, etc.

Multimedia processor 42 may generate image content for many different perspectives (e.g., viewing angles). Therefore, multimedia processor 42 may include a GPU that is capable of performing operations to generate image content for many different perspectives in a relatively short amount of time (e.g., generate a frame of image content every 33.3 ms).

As illustrated in FIG. 2, display device 16 includes eye pose sensing circuit 20, wireless controller 46, connection processor 48, controller 50, multimedia processor 52, display panel 54, and visual inertial odometer (VIO) 56. Controller 50 may be a main controller for display device 16, and may control the overall operation of display device 16. In one example, controller 50 may be considered as the CPU of display device 16.

Display device 16 also includes memory 53. Examples of memory 53 include one or more volatile or non-volatile memories or storage devices, such as, e.g., random access memory (RAM), static RAM (SRAM), dynamic RAM (DRAM), erasable programmable ROM (EPROM), electrically erasable programmable ROM (EEPROM), flash memory, a magnetic data media or an optical storage media. In some examples, memory 53 stores instructions that cause controller 50 or multimedia processor 52 to perform the example techniques described in this disclosure.

As noted above, although the example techniques are described with respect to controller 50 and multimedia processor 52 performing various operations, the example techniques are not so limited. The various operations of controller 50 and multimedia processor 52 may be performed by one or more of the various example circuits illustrated in FIG. 2. Accordingly, the description of controller 50 and multimedia processor 52 performing specific operations is merely to assist with understanding. Similarly, the operations of connection processor 48, wireless controller 46, eye pose sensing circuit 20, and VIO 56 may be performed by controller 50 and multimedia processor 52. In some examples, one or more of controller 50, multimedia processor 52, eye pose sensing circuit 20, VIO 56, wireless controller 46, and connection processor 48 may be part of the same integrated circuit (IC).

Controller 50 may include fixed function circuitry or programmable circuitry, examples of which include a general-purpose or a special-purpose processor that controls operation of display device 16. A user may provide input to display device 16 to cause controller 50 to execute one or more software applications. The software applications that execute on controller 50 may include, for example, a VR or AR application, an operating system, a word processor application, an email application, a spread sheet application, a media player application, a media editing application, a graphical user interface application, a teleconferencing application or another program. The user may provide input to display device 16 via one or more input devices (not shown) such as a keyboard, a mouse, a microphone, a touch pad or another input device that is coupled to display device 16.

The software applications that execute on controller 50 may include one or more graphics rendering instructions that instruct multimedia processor 52 to cause the rendering of graphics data. In some examples, the software instructions may conform to a graphics API, such as the examples described above. In order to process the graphics rendering instructions, application controller 50 may issue one or more graphics rendering commands to multimedia processor 52 to cause multimedia processor 52 to perform some or all of the rendering of the graphics data. In some examples, the graphics data to be rendered may include a list of graphics primitives, e.g., points, lines, triangles, quadrilaterals, triangle strips, etc.

Display panel 54 may include a monitor, a television, a projection device, an LCD, a plasma display panel, a light emitting diode (LED) array, electronic paper, a surface-conduction electron-emitted display (SED), a laser television display, a nanocrystal display or another type of display unit. Display panel 54 may be integrated within display device 16. For instance, display panel 54 may be a screen of a mobile telephone handset or a tablet computer. Alternatively, display panel 54 may be a stand-alone device coupled to display device 16 via a wired or wireless communications link.

Eye pose sensing circuit 20 may include sensors and/or actuators for generating information indicative of a user's field of view. For example, eye pose sensing circuit 20 may generate eye pose data (e.g., eye-tracking circuitry, and the like) that indicates a position of the user's eye. VIO 56 may be circuitry configured to determine orientation of display device 16. For example, VIO 56 may receive motion information from an inertial measurement unit (IMU) or an accelerometer, and perform smoothing on the motion information to generate information indicative of the orientation of display device 16. For example, the output of VIO 56 may be an angle of rotation of display device 16 and a position of display device 16. VIO 56 may not be necessary in all examples, and in some examples, the output from the IMU or accelerometer may be indicative of the orientation of display device 16 without smoothing from VIO 56.

As shown, path 61 illustrates the transfer of eye pose data to and from display device 16 to host device 10. Specifically, controller 50 may receive eye pose data from eye pose sensing circuit 20 and receive orientation data from VIO 56. Multimedia processor 52 may receive eye pose data and orientation data from controller 50. Wireless controller 46 packages the eye pose data and orientation data, and connection processor 48 transmits the packaged user input over a wireless network, such as Wi-Fi network 40, to host device 10. At host device 10, connection processor 38 receives the transmitted eye pose data and orientation data, and wireless controller 36 unpackages the received user input for processing by multimedia processor 42. In this way, host device 10 may generate image content for a particular eye pose of a user's field of view and a particular orientation of display device 16.

In general, host device 10 generates image content information for presentation at display panel 54. More specifically, multimedia processor 42 may generate image content information for a user's field of view that is indicated by eye pose data generated by eye pose sensing circuit 20 and the orientation of display device 16 that is indicated by orientation data generated by VIO 56. For example, multimedia processor 42 may generate image content information that indicates one or more primitives arranged in a user's field of view that is indicated by eye pose data generated by eye pose sensing circuit 20 and the orientation data generated by VIO 56. In some examples, multimedia processor 42 may generate image content information that indicates a two-dimensional frame representative of the user's field of view.

Multimedia processor 42 may then encode the frames of image content to generate a bitstream of image content information for transmission to display device 16. Multimedia processor 42 may encode the frames using any one of various video coding techniques such as those described in the standards defined by MPEG-2, MPEG-4, ITU-T H.263, ITU-T H.264/MPEG-4, Part 10, Advanced Video Coding (AVC), the High Efficiency Video Coding (HEVC) standard, and extensions of such standards.

In the example of FIG. 2, display device 16 may receive, via path 59, image content information from host device 10. To transfer image content information from host device 10 to display device 16, path 59 may begin at application processor 30.

Application processor 30 provides an environment in which a variety of applications may run on host device 10. Application processor 30 may receive data for use by these applications from internal or external storage locations and/or internal or external sensors or cameras associated with host device 10. The applications running on application processor 30, in turn, generate image content information for presentation to a user of host device 10 and/or display device 16. In other examples, path 59 may begin at multimedia processor 42 or some other functional device that either generates image content information or receives image content information directly from the storage locations and/or sensors or cameras.

Multimedia processor 42 may process the received image content information for presentation on display panel 54 of display device 16. Wireless controller 36 packages the processed data for transmission. Packaging the processed data may include grouping the data into packets, frames or cells that may depend on the wireless communication standard used over Wi-Fi network 40. Connection processor 38 then transmits the processed data to display device 16 using Wi-Fi network 40. Connection processor 38 manages the connections of host device 10, including a P2P group communication session with display device 16 over Wi-Fi network 40, and the transmission and receipt of data over the connections.

The transfer of the image content information continues along path 59 at display device 16 when connection processor 48 receives the transmitted data from host device 10. Similar to connection processor 38 of host device 10, connection processor 48 of display device 16 manages the connections of display device 16, including a P2P group communication session with host device 10 over Wi-Fi network 40, and the transmission and receipt of data over the connections. Wireless controller 46 unpackages the received data for processing by multimedia processor 52.

The image content information that multimedia processor 52 receives includes information indicating the pose with which a frame is associated. Multimedia processor 52 may also receive information such as prediction modes, motion vectors, residual data and the like for decoding the encoded image content (e.g., for decoding blocks of a frame of image content). As an example, a frame may include individually decodable slices. Multimedia processor 52 may receive image content information such as prediction modes, motion vectors, and residual data for blocks within each of the slices.

There may be various ways in which multimedia processor 52 receives information indicating the pose with which a frame is associated. As one example, each packet/slice includes the rendering pose in a field such as the RTP header. As another example, the RTP header may include a time stamp of a pose, rather than the actual pose information. In such examples, multimedia processor 52 may store, in a buffer, time stamps of different poses determined by eye pose sensing circuit 20. Multimedia processor 52 may then determine the pose information associate with the frame based on the received time stamp and the time stamps stored in the buffer (e.g., the received time stamp is an entry in the buffer of pose information to determine the pose information associated with the frame). Other ways to indicate the pose associated with a frame are possible.

As described above, controller 50 may issue one or more graphics rendering commands to multimedia processor 52 to cause multimedia processor 52 to perform some or all of the rendering of the graphics data such as graphics primitives, e.g., points, lines, triangles, quadrilaterals, triangle strips, etc. The graphics data to be rendered is based on the eye pose and orientation of display device 16 at the time controller 50 transmitted information of eye pose and orientation to application processor 30.

In response to the instructions from controller 50, processing circuitry of multimedia processor 52 (e.g., a GPU of multimedia processor 52) renders the image content and stores the image content to an eye buffer within memory 53. One example of rendering means generating the image content, including pixel values for pixels within the image content. In some examples, controller 50 may output information to multimedia processor 52 that indicates the current orientation of display device 16 as outputted by VIO 56. For example, the orientation of display device 16 may have changed from when controller 50 transmitted information indicating the orientation of display device 16 to when the GPU of multimedia processor 52 rendered the image content.

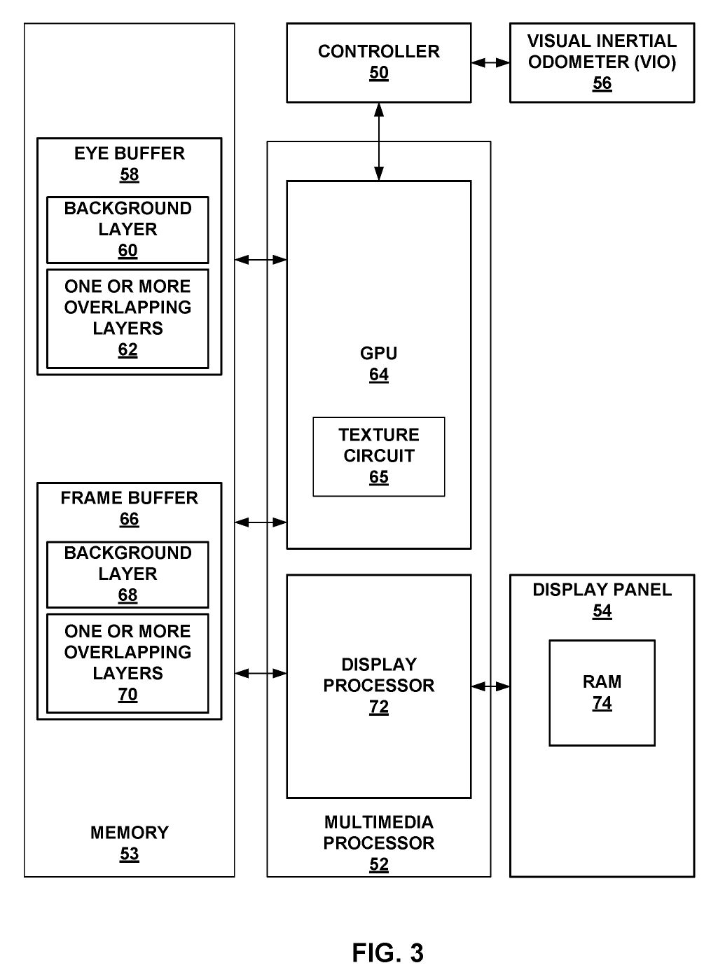

The processing circuitry of multimedia processor 52 (e.g., GPU of multimedia processor 52) may warp the image content stored in the eye buffer based on the current orientation of display device 16, and generate a warped image frame that multimedia processor 52 stores in a frame buffer of memory 53. Processing circuitry of multimedia processor 52 (e.g., a display processor) receives the warped image frame from the frame buffer and outputs the image content of the warped image frame to display panel 54 for display. An example of warping is described in more detail with respect to FIG. 3.

As described above, warping image content to generate the warped image frame is computationally expensive, and may require higher operating frequency for the processor, causing the processor to consume a relatively high amount of power. In this disclosure, rather than always performing the warping operation, the processor (e.g., the GPU) may be configured to selectively perform the warping operation, such as based on whether there is any change in orientation of display device 16. While a user does change the orientation of display device 16 while viewing image content, how often the user changes orientation may be relatively low. Therefore, by selective performing the warping operation, the overall power usage of multimedia processor 52, and therefore, the overall power usage of display device 16 may be reduced.

As one example, at time T1, the GPU of multimedia processor 52 may complete rendering of image content of frame 1 to the eye buffer. Controller 50 may determine whether the orientation of display device 16 changed from the time when the GPU processed a previous frame (e.g., frame 0 stored in the frame buffer) to the rendering of the current frame (e.g., frame 1). For example, during the processing of image content for frame 0, the GPU may have performed warping to generate frame 0 (for example, if there was change in orientation of display device 16 between frame 0 and frame −1). To perform the warping to generate frame 0, controller 50 may have determined, based on information from VIO 56, the current orientation of display device 16. In some examples, the current orientation of display device 16 can be the orientation of display device 16 at the time the warping operation starts and/or the last orientation of display device 16 prior to starting the warping operation. The current orientation may also be referred to as the orientation of display device 16 at time T0.

After the GPU renders the image content of frame 1 to the eye buffer, controller 50 may determine the orientation of display device 16 at time T1. In one example, controller 50 may determine whether there is a change in orientation of display device 16. For example, controller 50 may determine whether there is a difference in the orientation of display device 16 at time T0 and the orientation of display device 16 at time T1.

If there is no difference, then the GPU may bypass the warping operation to avoid warping entire image content of a frame. However, if there is difference, then the GPU may perform the warping operation. For example, if there is no difference in the orientation of display device 16 at time T0 and the orientation of display device 16 at time T1, that may mean that the user did not change the orientation of display device 16 from the time that display device 16 displayed frame 0 to the time that display device 16 is to display frame 1. If there is no change in orientation, then the warping operation may consume power but provide little to no benefit. If there is a change in orientation, then the warping operation may be beneficial.

In this example, controller 50 may have determined the orientation of display device 16 at time T0 (e.g., after rendering image content of frame 0 to the eye buffer) to determine whether to perform the warping operation to generate frame 0. Controller 50 may store the orientation of display device 16 at time T0, in memory 53, as a value represented by orientation 0. Then, controller 50 may have determined the orientation of display device 16 at time T1 (e.g., after rendering image content of frame 1 to the eye buffer) to determine whether to perform the warping operation to generate frame 1. Controller 50 may store the orientation of display device 16 at time T1, in memory 53, as a value represented by orientation 1.

Controller 50 may subtract the value of orientation 1 from the value of orientation 0. If an absolute value of the result of the subtraction is less than a threshold difference value, the orientation of display device 16 may not have changed. In this example, the GPU may bypass the warping operation. However, if the absolute value of the result of the subtraction is greater than or equal to a threshold difference value, the orientation of display device 16 may have changed. In this example, the GPU may perform the warping operation.

Accordingly, in one or more examples, processing circuity such as controller 50, multimedia processor 52, or some other processing circuitry may determine whether there is change in orientation of display device 16 between processing of a first frame and after rendering of a second frame. As one example, the processing circuitry may determine whether there is change in orientation of display device 16 at time T0 and at time T1. In one example, time T0 is the instance when image content of a previous frame (e.g., frame 0 or first frame) is warped, and time T1 is the instance after image content of a current frame (e.g., frame 1 or second frame) is rendered to the eye buffer.

There may be other examples of the time between processing of a first frame and rendering of a second frame. As one example, the processing of the first frame may refer to the time when the GPU completed rendering the image content of the first frame (e.g., frame 0) to the eye buffer, and before the determination of whether to warp frame 0. As another example, the processing of the first frame may refer to the time when the GPU stored the warped image content to generate frame 0 to the frame buffer. Additional examples of a time between processing of a first frame and rendering of a second frame are possible, and the techniques described in this disclosure are not limited to these examples.

In the above examples, controller 50 determined whether there was change in orientation of display device 16 between two different frames. However, the example techniques are not so limited. In some examples, controller 50 may determine whether there is a change in orientation of display device 16 between the time when display device 16 sent information indicating the orientation of display device 16, and the orientation of display device 16 after rendering the image content to the eye buffer. If there is no change in the orientation, the GPU may bypass the warping operation. If there is change in the orientation, the GPU may perform the warping operation.

In some examples, processing circuitry may determine whether there is change in orientation of display device 16 between rendering a first frame and after warping of a second frame. In some examples, the first frame and the second frame may be different frames, and in some examples, the first frame and the second frame may the same frame. In examples where the first frame and the second frame are the same frame, processing a first frame may refer to controller 50 transmitting orientation information for receiving image content for a frame and rendering that frame to the eye buffer, and warping the second frame may refer to the GPU warping image content of the first frame stored in eye buffer (again, in this example, the second frame and first frame are the same). In examples where the first frame and the second frame are different frames, processing a first frame may refer to the GPU generating image content and, in some instances outputting the image content of a previous frame to a frame buffer, and rendering the second frame may refer to the GPU generating image content of the second, current frame for storage in the eye buffer.

In examples where the GPU performed the warping operation on image content of a frame, the GPU may store the warped image content in the frame buffer. A display processor retrieves the image content in the frame buffer and causes display panel 54 to display the image content. However, in some examples, where the GPU does not perform warping operation on the image content, the GPU may not need to store image content to the frame buffer.

As one example, the processing circuitry (e.g., controller 50, multimedia processor 52, or some other circuitry) may determine that there is no change in orientation of display device 16 between processing a first frame (e.g., frame 0) and after rendering a second frame (e.g., frame 1). Additionally, the processing circuitry may determine that there is no change in the image content between the first frame and the second frame. In this example, the image content of frame 0 and frame 1 may be the same. Therefore, there may be no benefit of storing image content from the eye buffer to the frame buffer because the image content in the frame buffer is already that of frame 1. Again, in this example, image content of frame 0 and frame 1 may be the same. Accordingly, in some examples, the GPU may bypass storage of image content of frame 1 to the frame buffer, which conserves additional power, because the frame buffer already stores image content which is the same as the image content of frame 1. In such examples, the display processor may retrieve the image content from the frame buffer, which is the image content of frame 0, and cause display panel 54 to redisplay the image content of frame 0. For the user, there may be no impact on viewing experience because the image content of frame 0 and frame 1 is the same.

In some examples, the orientation of display device 16 may not change frame-to-frame, but there may be some frame-to-frame changes to the image content. In other words, processing circuitry may determine that there is change in image content between frame 0 and frame 1. As one example, the application executing on controller 50 may instruct the GPU to generate image content for a background layer and one or more layers overlapping layers that overlap the background layer. The background layer may be fixed frame-to-frame, but the image content in the overlapping layers may change. As an example, the application executing on controller 50 may be for a gaming application in which a player is shooting a basketball. In this example, the background layer may include the basketball court, the basketball hoop, the bleachers, and the like, which tend not to move and are in the background. The player and the basketball may be part of the overlapping layers that overlap the background and may be considered as objects that tend to move frame-to-frame.

In such examples, rather than the GPU replacing the entirety of the image content of frame 0 with the entirety of the image content of frame 1, the GPU may update the portions of frame 0 that changed with corresponding portions of frame 1, and reuse the remaining the portions of frame 0. As one example, the GPU may perform texture mapping to replace portions of image content in the frame buffer with corresponding portions of image content in the eye buffer. For instance, the frame buffer may store frame 0 because frame 0 is the frame generated before frame 1 and remains stored in the frame buffer until replaced with frame 1 (if needed). The GPU may render image content for frame 1 to the eye buffer. The GPU may then update portions of the frame buffer with portions of the eye buffer that store image content that changed from frame 0 to frame 1.

In some examples, when updating portions of the frame buffer with portions of the eye buffer, the GPU may perform texture mapping based on the current orientation of display device 16. For instance, previously, the GPU rendered image content of frame 0 to the eye buffer, and then performed warping as part of storing the image content of frame 0 from the eye buffer to the frame buffer. Then, as part of rendering frame 1 to the eye buffer, the GPU may update the portions of the eye buffer that have image content that changed from frame 0 to frame 1. For example, the image content in the top-left tile of frame 0 may be different than the image content in the top-left tile of frame 1, and the rest of the image content may be the same. In this example, the GPU may update the portion of the eye buffer that stores the top-left tile of frame 0 with the top-left tile of frame 1, but not update any other portion of the eye buffer.

Then, when storing image content from the eye buffer to the frame buffer, the GPU may perform texture mapping based on the current orientation of display device 16. One example reason why the GPU accounts for the current orientation of display device 16 is because the GPU performed warping when storing image content from the eye buffer to the frame buffer for frame 0. Therefore, what is stored in the frame buffer is warped frame 0. But, in updating the eye buffer, the GPU updated the eye buffer with the image content of frame 1 relative to the un-warped image content of frame 0 (i.e., the eye buffer stored image content of frame 0 prior to warping). Therefore, the GPU may replace image content in the frame buffer with image content in the eye buffer based on the current orientation of display device 16. In this example, the orientation of display device 16 may not have changed from frame-to-frame. Accordingly, the current orientation of display device 16 may be the same as the previous orientation of display device 16.

In updating the frame buffer based on the eye buffer, the GPU may update the portions of the frame buffer that store image content that changed from frame-to-frame. Accordingly, the GPU may perform texture mapping by replacing a portion of the frame, and not the entirety of the frame buffer, by copying portions of the eye buffer to the frame buffer based on the orientation of display device 16. In this way, responsive to a determination that there is change in the image content between frame 0 and frame 1, the GPU may update a portion, and not the entirety, of the frame buffer that stores image content for frame 0 based on the change between frame 0 and frame 1.

For instance, the frame buffer stores image content of frame 0, and the eye buffer stores image content of frame 1. In some cases, the GPU may overwrite the image content of frame 0 stored in the frame buffer with the image content of frame 1 by retrieving the image content of frame 1 from the eye buffer and writing the image content to the frame buffer. However, rather than rewriting all of the frame buffer, in some examples, the GPU may update only portions of the frame buffer, and not the entirety, that store image content of frame 0 that changed from frame 0 to frame 1. As described above, in some examples, in updating only portions, the GPU may update portions based on the current orientation of display device 16.

As an example, 10% of frame 1 may be different than frame 0. In this example, the GPU may update only the portions of the frame buffer that store the 10% of frame 0 that is different than frame 1 with image content from the eye buffer. For the remaining 90%, the GPU may not update the frame buffer because the image content already stored in the frame buffer for frame 0 is the same as the corresponding image content for frame 1.

In some examples, the GPU, when storing image content to the eye buffer from frame 1, may determine the 10% of frame 1 that is different than frame 0. For example, as part of the rendering frame 1 to the eye buffer, the GPU may determine which tiles of frame 1 are different than which tiles of frame 0 stored in the eye buffer. By tracking the tiles, the GPU may determine which 10% is different in the eye buffer. Then, for this 10% of image content that is different, the GPU may copy this 10% of image content from the eye buffer to the frame buffer (e.g., replace the 10% of image content from eye buffer with corresponding 10% of image content in the frame buffer). However, as part replacing the image content, the GPU may determine where the corresponding 10% of image content for frame 1 that changes relative to frame 0 should be stored in the frame buffer (i.e., which portion of the frame buffer should be overwritten) based on the current orientation of display device 16.

To determine where to store the 10% portion of the image content stored in the eye buffer to the frame buffer, the GPU may perform a warping operation, but only on the portion of the image content that changed in the eye buffer, instead of performing the warping operation on the entire image content of the eye buffer. Example ways to perform the warping operation are described in more detail below, and the GPU may perform such operations, but only on the portion of the image content that changed when there is frame-to-frame change in image content but no change in orientation of display device 16.

Accordingly, rather than transferring all of the image content from the eye buffer to the frame buffer, the GPU may copy the image content of the overlapping layers that changed from the eye buffer to corresponding portions in the frame buffer. The GPU may not change the remainder of the image content of the frame buffer. In this way, the frame buffer stores the image content of frame 1 but less power is consumed because the image content that was the same between frame 0 and frame 1 is kept within the frame buffer and not updated.

There may be various ways in which the GPU or controller 50 may determine which portions of the image content changed from frame-to-frame. As one example, the GPU may be configured to generate image content in a tiled-architecture. In a tiled-architecture, a frame is divided into tiles, and the GPU generates image content on a tile-by-tile basis. In the tile architecture, the GPU renders image content of a tile to a tile buffer, which may be a memory local to multimedia processor 52. The GPU then writes the image content of the tile buffer to the eye buffer, which may be in memory 53.

In some examples, the GPU may be configured to only write image content to a tile buffer of a tile, if the image content in the tile buffer changed from frame-to-frame. For instance, if a pixel shader executed for a particular pixel, the execution of the pixel shader may be indicative of change in the image content of a tile. Additional information for using pixel shader execution to determine whether there is change in image content of a tile can be found in U.S. Patent Publication No. 2017/0161863. A graphics driver executing on controller 50 may track which tiles had change in image content from tile-to-tile, and determine which portions of the image content changed from frame-to-frame based on for which tiles the image content changed.

For example, controller 50 may determine to which buffers (e.g., which tile buffers) the GPU is writing image content of tiles of a current frame during rendering of the current frame. In such examples, controller 50 or the GPU may determine that there is change in image content between a current and previous frame and that change corresponds to the buffers to which the GPU is writing or wrote image content. As an example, if the image content of a first tile changed from previous frame to current frame, then the GPU may be writing or may have written to the tile buffer that was previously storing image content of the first tile. By determining that the GPU is writing or wrote image content to the tile buffer that stores image content of the first tile of the previous frame, controller 50 or the GPU may determine that the image content of the first tile changed from previous to current frame.

As another example for determining which portions of the image content changed from frame-to-frame, controller 50 or the GPU may include hashing hardware or software that generates a unique hash value based on image content for a tile. Controller 50 or the GPU may store the hash value for a tile in memory. Then, after rendering a tile for the next frame, controller 50 or the GPU may compare the hash values. If the hash values are the same, controller 50 or the GPU may determine that there is no change in image content for that tile. If the hash values are different, controller 50 or the GPU may determine that there is change in the image content for that tile.

There may be other ways in which to determine whether image content changed from frame-to-frame, such as using time stamp comparisons. The techniques for selectively performing a warping operation described in this disclosure are not limited to any specific technique for determining whether image content changed.

After the GPU updates image content in the frame buffer based on image content in the eye buffer (e.g., either updates the entire frame stored in the frame buffer with the image content in the eye buffer, or performs texture mapping to update the portion of the frame buffer having image content that changed), processing circuitry (e.g., the display processor) of multimedia processor 52 blends the image content from the different layers to generate a composite frame for display. The display processor then outputs the composite frame to display panel 54 for display.

In some examples, the display processor continuously updates (e.g., line-by-line) display panel 54 with the composite frame. In some examples, display panel 54 includes internal memory that stores the composite frame, and in such examples, the display processor may not need to continuously update display panel 54. Rather, the display processor may store the composite frame in the memory of display panel 54. Circuitry within display panel 54 may read out the image content from the memory of display panel 54, and display the image content on display panel 54. In some examples where display panel 54 includes memory for storing the composite frame, the display processor may only update the portions of the memory of display panel 54 storing the composite frame with the image content that changed frame-to-frame. The display processor or controller 50 may determine which portions of the composite frame changed using hashing techniques, as one example, but other techniques such as timestamps are possible. One example technique for determining image content that changed is described in U.S. Patent Publication No. 2017/0032764.

FIG. 3 is a block diagram illustrating an example of the multimedia processor, memory, and display panel of FIG. 2 in greater detail. As illustrated, multimedia processor 52 includes GPU 64 and display processor 72. For ease of description, FIG. 3 is described with respect to GPU 64 and display processor 72 performing various functions. However, the techniques are not so limited. The example operations performed by GPU 64 and display processor 72 may be performed by common circuitry or by separate circuit components. For instance, the operations of GPU 64 may be performed by display processor 72 or vice-versa. Also, in some examples, controller 50, GPU 64, and display processor 72 may all be common circuitry or may be separate components with the circuitry.

In one or more examples, controller 50 may instruct GPU 64 to render image content for a frame based on instructions received from host device 10 and instructions from an application executing on controller 50. In response, GPU 64 generates image content for the frame.

For example, GPU 64 may implement a graphics processing pipeline to generate image content for eye buffer 58 of memory 53. As illustrated, GPU 64 may generate image content for background layer 60 and one or more overlapping layers 62 and store background layer 60 and one or more overlapping layers 62 in eye buffer 58. As one example, the application may define instructions for generating background layer 60, and define instructions for generating one or more overlapping layers 62. Background layer 60 and one or more overlapping layers 62 together form the image content for a frame.

In some examples, controller 50 may store information indicating the orientation of display device 16 based on which GPU 64 generated image content for background layer 60 and one or more overlapping layers 62. For example, controller 50 may have transmitted the orientation of display device 16, and received instructions and image content data based on the orientation. Controller 50 may store information indicating the orientation of display device 16 in memory 53 or internal memory of controller 50.

Controller 50 may determine the current orientation of display device 16 based on the current value from VIO 56. Controller 50 may compare the current orientation of display device 16 to the orientation of display device 16 when GPU 64 completed the rendering of a previous frame. If there is change in orientation, GPU 64 may perform the warping operation using texture circuit 65 and background layer 60 and one or more overlapping layers 62 of eye buffer 58 as input to generate background layer 68 and one or more overlapping layers 70. Texture circuit 65 may output background layer 68 and one or more overlapping layers 70 to frame buffer 66. For example, background layer 68 of frame buffer 66 may be the warped version of background layer 60 of eye buffer 58. One or more overlapping layers 70 of frame buffer 66 may the warped version of one or more overlapping layers 62 of eye buffer 58. Background layer 68 and one or more overlapping layers 70 together form the image content for a frame.

The following describes one example way in which texture circuit 65 may perform the warping operation. Texture circuit 65 and controller 50 may operate together to perform the warping operation.

Controller 50 may be configured to perform a homography based on the difference in the orientation of display device 16 when display device 16 sent information of display device 16 orientation to the current orientation of display device 16. Homography is the process by which controller 50 determines where a point based on previous orientation would be located in the current orientation. As one example, homography is a transformation where coordinates of a point in the background layer 60 or one or more overlapping layers 62 are multiplied by a 3×3 matrix to generate the coordinates of that point in the background layer 68 or one or more overlapping layers 70, respectively. Although controller 50 is described as determining the homography, the techniques are not so limited, and multimedia processor 52 may be configured to perform the homography.

The following is one example manner in which controller 50 may perform the homography. In one example, quaternion q1 represents the previous orientation of display device 16 (e.g., orientation of display device 16 for rendering the image content of a previous frame to eye buffer 58 or orientation of display device 16 for warping the image content of a previous frame to frame buffer 66). For example, q1 could be in the OpenGL™ format glm::quat, where glm stands for OpenGL™ Mathematics, and quat is short for quaternion. Similarly, q2 represents the quaternion of orientation of display device 16 for the current frame (e.g., orientation of display device 16 for rendering the image content of the current frame to eye buffer 58 or orientation of display device 16 for warping the image content of the current frame to frame buffer 66). Controller 50 may first determine the difference between the orientations as a third quaternion q3=glm::inverse(q2)*q1. Controller 50 may compute the homography corresponding to this difference using the method glm::mat4_cast(q3) in accordance with the OpenGL API.

As described above, in performing the homography, controller 50 may determine the coordinates of where points of background layer 60 and one or more overlapping layers 62 are to be located. Based on the determined coordinates and the color values of the pixels, controller 50 may cause texture circuit 65 to warp the image content.

One example way in which to perform the warping is via texture mapping. In texture mapping, texture circuit 65 maps image content from a texture (e.g., the previous frame) to a frame mesh defined by controller 50 and possibly generated by tessellation by GPU 64. In this example, texture circuit 65 receives the coordinates of vertices in background layer 60 and one or more overlapping layers 62 and coordinates for where the vertices are to be mapped on the frame mesh based on the homography determined by controller 50. In turn, texture circuit 65 maps the image content of the vertices to points on the frame mesh determined from the homography. The result is the warped image content (e.g., background layer 68 and one or more overlapping layers 70).

For example, to perform the homography, controller 50 determines a projection matrix based on the previous and current orientation information. As described above, controller 50 may utilize OpenGL™ commands such as glm for computing the homography. The orientation information may be part of the quaternion definition of the current frame, where the quaternion is a manner in which to define a three-dimensional space. The resulting homography may be a 3×3 projection matrix, also called rotation matrix, with which texture circuit 65 performs the warping.

GPU 64 executes a vertex shader that transforms the vertex coordinates of primitives in background layer 60 and one or more overlapping layers 62 to projected vertex coordinates based on the projection matrix (e.g., rotation matrix). Texture circuit 65 receives the pixel values of pixels on the vertices of primitives in background layer 60 and one or more overlapping layers 62, the vertex coordinates of the primitives in background layer 60 and one or more overlapping layers 62, and the projected vertex coordinates. Texture circuit 65 then maps the image content in background layer 60 and one or more overlapping layers 62 based on the pixel values, the vertex coordinates of the primitives in background layer 60 and one or more overlapping layers 62, and the projected vertex coordinates onto a frame mesh. GPU 64 executes fragment shaders to generate the color values for the pixels within the frame mesh to generate the warped frame. The warped frame includes background layer 68 and one or more overlapping layers 70

This example technique to generate the warped frame is referred to as applying asynchronous time warp (ATW). In some examples, controller 50 and texture circuit 65 may apply ATW with depth. For instance, in ATW, controller 50 may determine that the coordinate for each vertex in background layer 60 and one or more overlapping layers 62 is (x, y, 1), where each vertex is assigned a depth of 1. In ATW with depth, controller 50 may receive depth information in background layer 60 and one or more overlapping layers 62, where the depth information indicates the depth of vertices in background layer 60 and one or more overlapping layers 62. Controller 50 may then assign each vertex the coordinates of (x, y, z), where the z value is based on the depth indicated by the depth map. The other operations of texture circuit 65 may be the same.

In some examples, controller 50 may additionally or alternatively apply asynchronous space warping (ASW). In ATW or ATW with depth, controller 50 accounts for the difference in the image content in background layer 60 and one or more overlapping layers 62 based on the difference in amount of time that elapsed. In ASW, controller 50 may account for movement of image content within the frames. For instance, controller 50 may use motion vectors of blocks in background layer 60 and one or more overlapping layers 62 to generate the projection matrix. Similar to ATW with depth, in some examples, controller 50 may use depth information with ASW. In ATW, ATW with depth, ASW, and ASW with depth, the manner in which controller 50 generates the projection matrix may be different. However, once the projection matrix is generated, the texture mapping techniques to generate the warped frame may be generally the same.

There may be other ways in which to perform the warping of the image content in background layer 60 and one or more overlapping layers 62 than the example techniques described above. For instance, the above warping techniques include asynchronous time warp (ATW), ATW with depth, asynchronous space warp (ASW), ASW with depth, and other techniques.

As described above, the example warping techniques may be computationally intensive and time consuming. Accordingly, in one or more examples, GPU 64 may selectively perform the warping operations.

For example, during the warping of frame 0 (e.g., warping background layer 60 and one or more overlapping layers 62 to generate background layer 68 and one or more overlapping layers 70 for frame 0), controller 50 may have determined the orientation of display device 16 and stored the orientation information, referred to as previous orientation. Then, for frame 1, after generating background layer 60 and one or more overlapping layers 62 for fame 1, controller 50 may determine the orientation of display device 16, referred to as current orientation.

If the previous and current orientations are different, controller 50 may cause GPU 64 to perform the warping operation. If, however, the previous and current orientations are the same, then GPU 64 may bypass the warping operation (e.g., skip the warping operation) to avoid warping entire image content of a frame.

In the example where GPU 64 is to bypass the warping operation to avoid warping entire image content of a frame, controller 50 or GPU 64 may determine whether there is any change in the image content between frame 0 and frame 1. For example, based on for which tiles GPU 64 rendered image content to a tile buffer or based on hash values generated for each tile by controller 50 or GPU 64, controller 50 or GPU 64 may determine whether the image content for frame 0 and frame 1 is the same. For example, the image content for frame 0 is the image content stored in frame buffer 66 (e.g., the combination of background layer 68 and one or more overlapping layers 70). The image content for frame 1 is the image content stored in eye buffer 58 (e.g., the combination of background layer 60 and one or more overlapping layers 62).

If the image content for frame 0 and frame 1 is the same, then GPU 64 may not update frame buffer 66. For example, while eye buffer 58 stores the image content for frame 1, frame buffer 66 may store the image content for frame 0. In this case, if the image content of frame 0 and frame 1 is the same, then there may be no need to update background layer 68 and one or more overlapping layers 70 in frame buffer 66.

If, however, the image content for frame 0 and frame 1 is not the same, then GPU 64 may update frame buffer 66 but only update portions that changed between frames. As one example, texture circuit 65 may texture map tiles of frame 1 that are different than corresponding tiles of frame 0 to the portion of frame buffer 66 that is to be updated. For instance, a first portion of frame buffer 66 stores image content for a first tile of frame 0, and a second portion of frame buffer 66 stores image content for a second tile of frame 0. If a first tile of frame 1, that is in the same location in frame 1 as the first tile is in frame 0 (e.g., corresponding tile), is different than the first tile of frame 0, then texture circuit 65 may update the first portion of frame buffer 66 with the first tile of frame 1. If a second tile of frame 1, that is in the same location in frame 1 as the second tile in frame 0 (e.g., corresponding tile), is the same as the first tile of frame 0, then texture circuit 65 may not update the second portion of frame buffer 66. In this way, texture circuit 65 may texture map tiles of frame 1 that are different than corresponding tiles of frame 0 to respective portions of frame buffer 66.

For instance, texture circuit 65 may perform texture mapping operations to copy portions of background layer 60 and/or one or more overlapping layers 62 for frame 1 stored in eye buffer 58 into corresponding portions of background layer 68 and one or more overlapping layers 70 of frame buffer 66 for frame 0. In some examples, texture circuit 65 may perform warping operations as part of the texture mapping when copying portions of background layer 60 and/or one or more overlapping layers 62 for frame 1 stored in eye buffer 58 into corresponding portions of background layer 68 and one or more overlapping layers 70. This way only the portions of frame buffer 66 having image content that changed are updated. GPU 64 does not have to copy all of background layer 60 and one or more overlapping layers 62 from eye buffer 58 to background layer 68 and one or more overlapping layers 70 of frame buffer 66. As one example, texture circuit 65 may replace a first portion of frame buffer 66 that stores image content of a first tile of frame 0 with a tile from frame 1 (e.g., a tile from overlapping layers 62 replaces a tile from overlapping layers 70) based on a current orientation of display device 16.

Regardless of whether GPU 64 updates background layer 68 and one or more overlapping layers 70, display processor 72 receives background layer 68 and one or more overlapping layers 70 from frame buffer 66 and blends the layers together to form a composite frame. In one example, display processor 72 stores the composite frame in RAM 74 of display panel 54; however, memory other than RAM may be used in place of or in addition to RAM 74.

In one or more examples, rather than storing the entirety of the composite frame to RAM 74, display processor 72 may update only the portions of RAM 74 that changed frame-to-frame. In this manner, display processor 72 may not need to read in or write out as much information as compared to if display processor 72 updated RAM 74 with the entire composite frame.

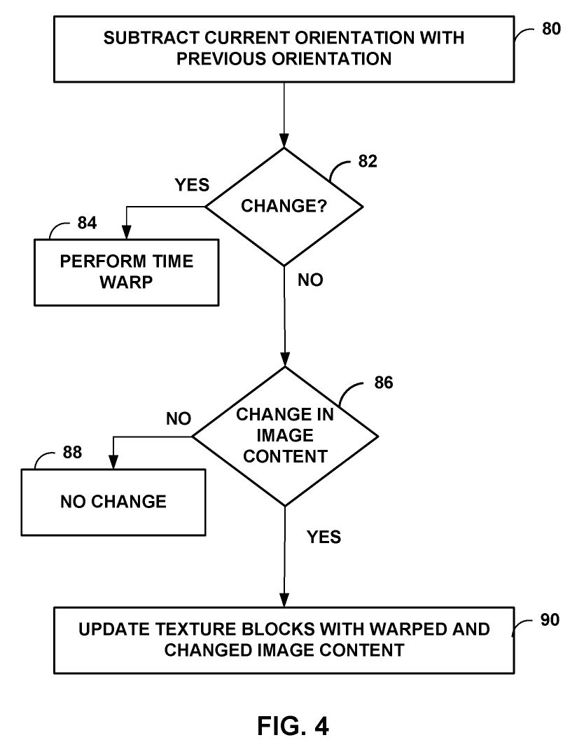

FIG. 4 is a flowchart illustrating an example method of image processing in accordance with one or more examples described in this disclosure. As described above, controller 50 may store the previous orientation, which in one example, is the orientation of display device 16 when processing a first frame (e.g., when warping a previous frame). As an example, controller 50 may execute a VR or AR application. In response to executing the VR or AR application, controller 50 may cause connection processor 48 to output information indicative of a first orientation of display device 16 as measured by VIO 56 and/or eye pose sensing circuit 20. Controller 50 may receive image content from host device 10 for the first frame based on the first orientation, and controller 50 and multimedia processor 52 may process the first frame based on the received image content for the first frame (e.g., generate the image content for the first frame and store the image content in frame buffer 66).

Subsequent to processing the first frame, in response to executing the VR or AR application, controller 50 may cause connection processor 48 to output information indicative of a second orientation of display device 16 as measured by VIO 56 and/or eye pose sensing circuit 20. Controller 50 may receive image content from host device 10 for a second frame based on the second orientation. Controller 50 and multimedia processor 52 may render the second frame based on the received image content for the second frame (e.g., generate the image content for the second frame and store the image content in eye buffer 58). After the rendering of the second frame (e.g., storing the image content of the second frame in eye buffer 58), controller 50 may also determine the current orientation, which in one example, is the orientation of display device 16 after rendering of the second frame (e.g., rendering of the current frame to eye buffer 58).

As illustrated, processing circuitry (e.g., controller 50, multimedia processor 52, or some other programmable or fixed-function circuitry) may subtract the current orientation from the previous orientation, or vice-versa (80). The processing circuitry may determine whether there is change in orientation based on the result of the subtraction (82). For example, if the result of the subtraction is a value less than a threshold, the processing circuitry may determine that there is no change in orientation, and if the result of the subtraction is a value greater than or equal to the threshold, the processing circuity may determine that there is change in orientation. If there is change in orientation (YES of 82), the processing circuitry may configure GPU 64 to perform the warping operation (84). For example, the processing circuitry, such as with texture circuit 65, may warp the image content stored in eye buffer 58 for the current frame based on the current orientation of display device 16.

If, however, there is no change in orientation (NO of 82), the processing circuitry may determine whether there is change in image content (86). If there is no change in image content (NO of 86), then there may be no change to frame buffer 66, and operations to update frame buffer 66 may also be bypassed (88). If there is change in image content (YES of 86), then the processing circuitry may determine for which blocks there was change in image content and texture circuit 65 may update texture blocks with the changed image content (90). For example, texture circuit 65 may copy portions from eye buffer 58 into corresponding portions of frame buffer 66, rather than copy the entirety of image content for a frame from eye buffer 58 to frame buffer 66. As one example, texture circuit 65 may replace a portion of fame buffer 66 that stores image content of a tile of the previous frame with a tile from the current frame stored in eye buffer 58 based on a current orientation of display device 16.

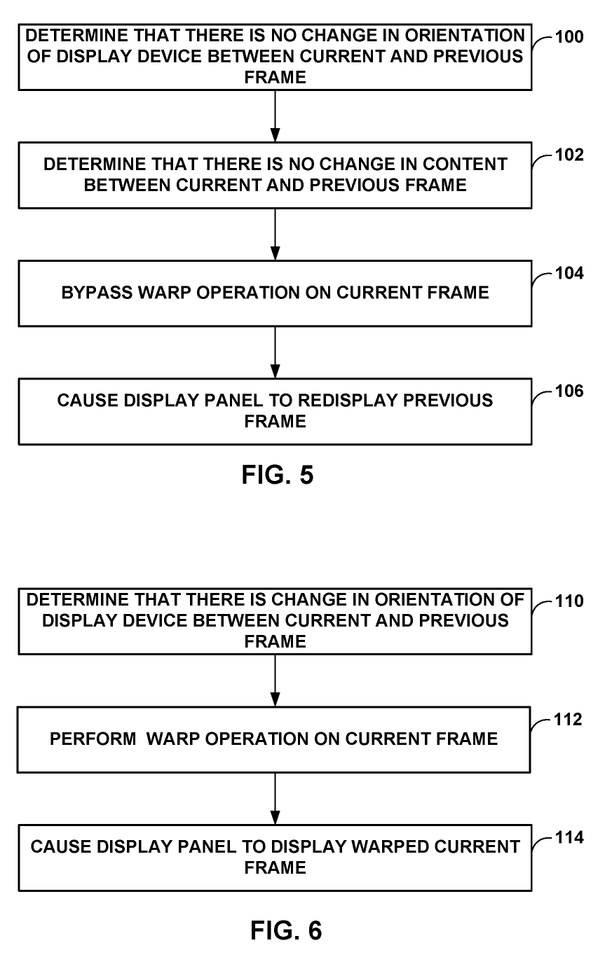

FIG. 5 is a flowchart illustrating an example method of image processing when there is no change in display device orientation, in accordance with one or more examples described in this disclosure. In this example, processing circuitry may determine that there is no change in orientation of display device 16 between a current frame and a previous frame (100). For example, the subtraction operation in block 80 of FIG. 4 results in a value that is less than a difference threshold.

The example of FIG. 4 was described with respect to a first frame and a second frame. In FIG. 5, the current frame is a fourth frame, and the previous frame is a third frame. In response to executing a VR or AR application, controller 50 may cause connection processor 48 to output information indicative of a third orientation of display device 16 as measured by VIO 56 and/or eye pose sensing circuit 20. Controller 50 may receive image content from host device 10 for the third frame based on the third orientation, and controller 50 and multimedia processor 52 may process the third frame based on the received image content for the third frame (e.g., generate the image content for the third frame and store the image content in frame buffer 66). Controller 50 may also store information indicative of the orientation of display device 16 before, during, and/or after processing the third frame, as the previous orientation of display device 16.

Subsequent to processing the third frame, in response to executing the VR or AR application, controller 50 may cause connection processor 48 to output information indicative of a fourth orientation of display device 16 as measured by VIO 56 and/or eye pose sensing circuit 20. Controller 50 may receive image content from host device 10 for a fourth frame based on the fourth orientation. Controller 50 and multimedia processor 52 may render the fourth frame based on the received image content for the fourth frame (e.g., generate the image content for the fourth frame and store the image content in eye buffer 58). After the rendering of the fourth frame (e.g., storing the image content of the fourth frame in eye buffer 58), controller 50 may also determine the current orientation, which in one example, is the orientation of display device 16 after rendering of the fourth frame (e.g., rendering of the current frame to eye buffer 58).

In this example, the processing circuitry may subtract the value of the previous orientation (e.g., orientation of display device 16 before, after, and/or during processing of the third frame) from the value of the current orientation (e.g., orientation of display device 16 after rendering the fourth frame), or vice-versa. If the value of the difference is less than a threshold value, the processing circuitry may determine that that there is no change in orientation of display device 16 between a current frame (e.g., fourth frame) and a previous frame (e.g., third frame).

The processing circuitry may also determine that there is no change in content between the current frame and the previous frame (102). For example, a comparison of hash values for tiles of the current frame and the previous frame may indicate that there is no change in image content (e.g., the hash values are the same).

As another example, during the rendering of the previous frame, the processing circuitry may have written image content of a first tile in the previous frame to a portion of the tile buffer. Then during rendering of the current frame, the processing circuitry may only overwrite the portion of the tile buffer if the first tile in the current frame that corresponds to the first tile in the previous frame changed. If the GPU is writing or wrote to the portion of the tile buffer that stored the image content of the first tile of the previous frame with the image content of the first tile of the current frame, the processing circuitry may determine that the image content in the first tile changed from the previous frame to the current frame.

Accordingly, the processing circuitry may determine to which buffers (e.g., which tile buffers or to which portions of the tile buffer) the processing circuitry is writing image content of tiles of the current frame during rendering of the current frame. In such examples, the processing circuitry may determine that there is change in image content between the previous frame and the current frame that correspond to the buffers to which the processing circuitry is writing or wrote image content. For instance, if the image content of the previous frame that was written to the tile buffer is overwritten by the processing circuity for the current frame, then the portion of the image content that was stored in the tile buffer and then overwritten is image content that changed from the previous frame to the current frame.

In this example, the processing circuitry may bypass the warp operation on the current frame to avoid warping entire image content of the current frame (104). Rather, the processing circuitry may cause display panel 54 to redisplay previous frame (106). For example, if there is no change in image content, then frame buffer 66 already stores the image content for the current frame (e.g., because there is no change in image content). Therefore, display processor 72 may cause display panel 54 to redisplay the previous frame stored in frame buffer 66. In some examples, display processor 72 may have already stored the image content of frame buffer 66 into RAM 74. In such examples, display processor 72 may cause display panel 54 to redisplay the image content stored in RAM 74.

FIG. 6 is a flowchart illustrating an example method of image processing when there is change in display device orientation, in accordance with one or more examples described in this disclosure. In this example, processing circuitry may determine that there is change in orientation of display device 16 between a current frame and a previous frame (110). For example, the subtraction operation in block 80 of FIG. 4 results in a value that is greater than or equal to a difference threshold.

For instance, in response to executing a VR or AR application, controller 50 may cause connection processor 48 to output information indicative of a first orientation of display device 16 as measured by VIO 56 and/or eye pose sensing circuit 20. Controller 50 may receive image content from host device 10 for the first frame based on the first orientation, and controller 50 and multimedia processor 52 may process the first frame based on the received image content for the first frame (e.g., generate the image content for the first frame and store the image content in frame buffer 66). Controller 50 may also store information indicative of the orientation of display device 16 before, during, and/or after processing the first frame, as the previous orientation of display device 16.

Subsequent to processing the first frame, in response to executing the VR or AR application, controller 50 may cause connection processor 48 to output information indicative of a second orientation of display device 16 as measured by VIO 56 and/or eye pose sensing circuit 20. Controller 50 may receive image content from host device 10 for a second frame based on the second orientation. Controller 50 and multimedia processor 52 may render the second frame based on the received image content for the second frame (e.g., generate the image content for the second frame and store the image content in eye buffer 58). After the rendering of the second frame (e.g., storing the image content of the second frame in eye buffer 58), controller 50 may also determine the current orientation, which in one example, is the orientation of display device 16 after rendering of the second frame (e.g., rendering of the current frame to eye buffer 58).

In this example, the processing circuitry may subtract the value of the previous orientation (e.g., orientation of display device 16 before, after, and/or during processing of the first frame) from the value of the current orientation (e.g., orientation of display device 16 after rendering the second frame), or vice-versa. If the value of the difference is greater than or equal to a threshold value, the processing circuitry may determine that that there is change in orientation of display device 16 between a current frame (e.g., second frame) and a previous frame (e.g., first frame).

In this example, the processing circuitry may perform the warp operation on the current frame (112). For example, controller 50 and texture circuit 65 may perform the warping operation on the image content stored in eye buffer 58 (e.g., background layer 60 and one or more overlapping layers 62) to generate the image content for frame buffer 66 (e.g., background layer 68 and one or more overlapping layers 70).

Display processor 72 may cause display panel 54 to display the warped current frame (114). For example, display processor 72 may composite background layer 68 and one or more overlapping layers 70 to generate the composite layer, and cause display panel 54 to display the composite layer.

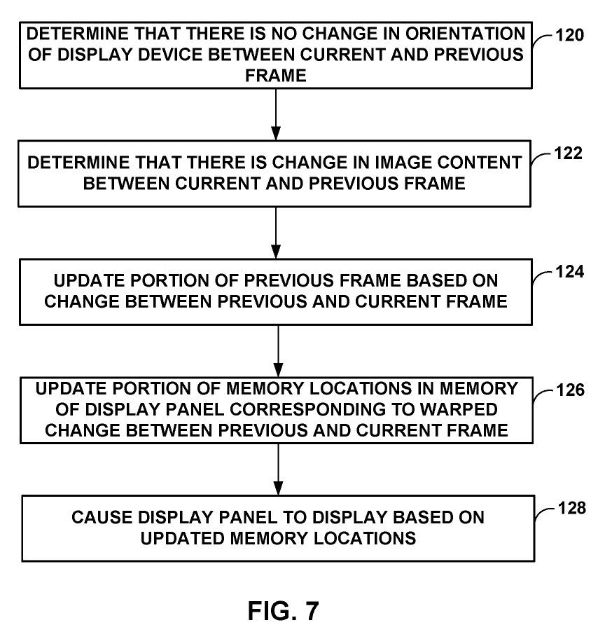

FIG. 7 is a flowchart illustrating an example method of image processing when there is no change in display device orientation and change in image content between current frame and previous frame, in accordance with one or more examples described in this disclosure. In this example, processing circuitry may determine that there is no change in orientation of display device 16 between a current frame and a previous frame (120). For example, the subtraction operation in block 80 of FIG. 4 results in a value that is less than a difference threshold.

The processing circuitry may also determine that there is change in content between the current frame and the previous frame (122). For example, a comparison of hash values for tiles of the current frame and they previous frame may indicate that there is change in image content (e.g., the hash values are different).

In this example, the processing circuitry may update a portion of previous frame based on change between the previous and the current frame (124). For example, frame buffer 66 stores the image content for the previous frame (e.g., background layer 68 and one or more overlapping layers 70), and eye buffer 58 stores the image content for the current frame (e.g., background layer 60 and one or more overlapping layers 62). In this example, texture circuit 65 may update portions in frame buffer 66 having image content that changed, and not update the entirety of frame buffer 66 with the image content from eye buffer 58.

In some examples, after display processor 72 composites the image content in frame buffer 66 (e.g., composites background layer 68 and one or more overlapping layers 70), display processor 72 may update only portions of RAM 74 that correspond to the change between the previous and the current frame (e.g., update only the portions of RAM 74 that changed frame-to-frame) (126). Display processor 72 may cause display panel 54 to display based on the updated memory locations of RAM 74 (128).

In one or more examples, the functions described may be implemented in hardware, software, firmware, or any combination thereof. If implemented in software, the functions may be stored on or transmitted over as one or more instructions or code on a computer-readable medium. Computer-readable media may include computer data storage media or communication media including any medium that facilitates transfer of a computer program from one place to another. In some examples, computer-readable media may include non-transitory computer-readable media. Data storage media may be any available media that can be accessed by one or more computers or one or more processors to retrieve instructions, code and/or data structures for implementation of the techniques described in this disclosure.

By way of example, and not limitation, such computer-readable media can include non-transitory media such as RAM, ROM, EEPROM, CD-ROM or other optical disk storage, magnetic disk storage, or other magnetic storage devices, flash memory, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The code may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined integrated circuit. Also, the techniques could be fully implemented in one or more circuits or logic elements.

The techniques of this disclosure may be implemented in a wide variety of devices or apparatuses, including a wireless handset, an IC or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

Various examples of the aspects have been described. These and other aspects are within the scope of the following claims.

What is claimed is:

1. A method for image processing, the method comprising:
determining, with one or more processors, that there is change in orientation of a display device between processing a first frame and after rendering a second frame;
responsive to the determination that there was change in the orientation between processing the first frame and after rendering the second frame, performing, with the one or more processors, a warp operation on the second frame to warp image content of the second frame based on a current orientation of the display device after rendering the second frame;
determining, with the one or more processors, that there is no change in orientation of the display device between processing a third frame and after rendering of a fourth frame; and
responsive to the determination that there is no change in the orientation of the display device between processing the third frame and after rendering the fourth frame, bypassing a warp operation on the fourth frame to avoid warping entire image content of the fourth frame.

2. The method of claim 1, further comprising:
determining that there is change in image content between the third frame and the fourth frame; and
responsive to the determination that there is change in the image content between the third frame and the fourth frame, updating a portion, and not the entirety, of a frame buffer that stores image content for the third frame based on the change between the third frame and the fourth frame.

3. The method of claim 2, wherein updating the portion comprises texture mapping tiles of the fourth frame that are different than corresponding tiles of the third frame to the portion of the frame buffer.

4. The method of claim 3, wherein the texture mapping comprises:
replacing the portion of the frame buffer that stores image content of a tile of the third frame with a tile from the fourth frame based on a current orientation of the display device after rendering the fourth frame.

5. The method of claim 2, further comprising:
determining to which buffer or buffers a graphics processing unit (GPU) is writing image content of tiles of the fourth frame during rendering of the fourth frame,
wherein determining that there is change in image content between the third frame and the fourth frame comprises determining that there is change in image content of tiles of the fourth frame that correspond to the buffers to which the GPU is writing or wrote image content.

6. The method of claim 2, further comprising:
determining a first hash value for the third frame; and
determining a second hash value for the fourth frame,
wherein determining that there is change in image content between the third frame and the fourth frame comprises determining that there is change in image content based on a difference between the first hash value and the second hash value.

7. The method of claim 1, further comprising:
causing a display panel to display the third frame;
determining that there is no change in image content between the third frame and the fourth frame; and
responsive to the determination that that there is no change in the orientation of the display device and that there is no change in image content between the third frame and the fourth frame, causing a display panel to redisplay the third frame.

8. The method of claim 1, wherein performing the warping operation comprises performing one or more of synchronous time warp (STW), STW with depth, asynchronous time warp (ATW), ATW with depth, asynchronous space warp (ASW), or ASW with depth.

9. The method of claim 1, wherein the display device comprises a wearable display device.

10. The method of claim 1, further comprising:
executing, on the display device, a virtual reality (VR) or augmented reality (AR) application corresponding to the first frame, the second frame, the third frame, and the fourth frame.

11. The method of claim 10, further comprising:
outputting information indicative of a first orientation of the display device;
receiving image content for the first frame based on the first orientation;
processing the first frame based on the received image content for the first frame;
subsequent to processing the first frame, outputting information indicative of a second orientation of the display device;
receiving image content for the second frame based on the second orientation;
rendering the second frame based on the received image content for the second frame;
outputting information indicative of a third orientation of the display device;
receiving image content for the third frame based on the third orientation;
processing the third frame based on the received image content for the third frame;
subsequent to processing the third frame, outputting information indicative of a fourth orientation of the display device;
receiving image content for the fourth frame based on the fourth orientation; and
rendering the fourth frame based on the received image content for the fourth frame.

12. A display device for image processing, the device comprising:
memory configured to store information indicative of orientation of the display device; and
processing circuitry configured to:
determine, based on the stored information, that there is change in orientation of a display device between processing a first frame and after rendering a second frame;
responsive to the determination that there was change in the orientation between processing the first frame and after rendering the second frame, perform a warp operation on the second frame to warp image content of the second frame based on a current orientation of the display device after rendering the second frame;
determine, based on the stored information, that there is no change in orientation of a display device between processing a third frame and after rendering of a fourth frame; and
responsive to the determination that there is no change in the orientation of the display device between processing the third frame and after rendering the fourth frame, bypass a warp operation on the fourth frame to avoid warping entire image content of the fourth frame.

13. The device of claim 12,
wherein the memory comprises a frame buffer that stores image content for the third frame, and
wherein the processing circuitry is configured to:
determine that there is change in image content between the third frame and the fourth frame; and
responsive to the determination that there is change in the image content between the third frame and the fourth frame, update the portion, and not the entirety, of the frame buffer that stores the image content for the third frame based on the change between the third frame and the fourth frame.

14. The device of claim 13, wherein to update the portion, the processing circuitry is configured to texture map tiles of the fourth frame that are different than corresponding tiles of the third frame to the portion of the frame buffer.

15. The device of claim 14, wherein to texture map, the processing circuitry is configured to:
replace the portion of the frame buffer that stores image content of a tile of the third frame with a tile from the fourth frame based on a current orientation of the display device after rendering the fourth frame.

16. The device of claim 13, wherein the processing circuitry is configured to:
determine to which buffer or buffers a graphics processing unit (GPU) is writing image content of tiles of the fourth frame during rendering of the fourth frame,
wherein to determine that there is change in image content between the third frame and the fourth frame, the processing circuitry is configured to determine that there is change in image content of tiles of the fourth frame that correspond to the buffers to which the GPU is writing or wrote image content.

17. The device of claim 13, wherein the processing circuitry is configured to:
determine a first hash value for the third frame; and
determine a second hash value for the fourth frame,
wherein to determine that there is change in image content between the third frame and the fourth frame, the processing circuitry is configured to determine that there is change in image content based on a difference between the first hash value and the second hash value.

18. The device of claim 12, wherein the processing circuity is configured to:
cause a display panel to display the third frame;
determine that there is no change in image content between the third frame and the fourth frame; and
responsive to the determination that that there is no change in the orientation of the display device and that there is no change in image content between the third frame and the fourth frame, cause a display panel to redisplay the third frame.

19. The device of claim 12, wherein to perform the warping operation, the processing circuitry is configured to perform one or more of synchronous time warp (STW), STW with depth, asynchronous time warp (ATW), ATW with depth, asynchronous space warp (ASW), or ASW with depth.

20. The device of claim 12, wherein the display device comprises a wearable display device.

21. The device of claim 12, wherein the processing circuitry is configured to:
execute a virtual reality (VR) or augmented reality (AR) application corresponding to the first frame, the second frame, the third frame, and the fourth frame.

22. The device of claim 21, wherein the processing circuity is configured to:
output information indicative of a first orientation of the display device;
receive image content for the first frame based on the first orientation;
process the first frame based on the received image content for the first frame;
subsequent to processing the first frame, output information indicative of a second orientation of the display device;
receive image content for the second frame based on the second orientation;
render the second frame based on the received image content for the second frame;
output information indicative of a third orientation of the display device;
receive image content for the third frame based on the third orientation;
process the third frame based on the received image content for the third frame;
subsequent to processing the third frame, output information indicative of a fourth orientation of the display device;
receive image content for the fourth frame based on the fourth orientation; and
render the fourth frame based on the received image content for the fourth frame.

23. A computer-readable storage medium storing instructions that when executed cause one or more processors of a display device for image processing to:
determine that there is change in orientation of the display device between processing a first frame and after rendering a second frame;
responsive to the determination that there was change in the orientation between processing the first frame and after rendering the second frame, perform a warp operation on the second frame to warp image content of the second frame based on a current orientation of the display device after rendering the second frame;
determine that there is no change in orientation of the display device between processing a third frame and after rendering of a fourth frame; and
responsive to the determination that there is no change in the orientation of the display device between processing the third frame and after rendering the fourth frame, bypass a warp operation on the fourth frame to avoid warping entire image content of the fourth frame.

24. The computer-readable storage medium of claim 23, wherein the display device comprises a wearable display device.

25. The computer-readable storage medium of claim 23, storing further instructions that cause the one or more processors to:
execute a virtual reality (VR) or augmented reality (AR) application corresponding to the first frame, the second frame, the third frame, and the fourth frame.

26. The computer-readable storage medium of claim 25, storing further instructions that cause the one or more processors to:
output information indicative of a first orientation of the display device;
receive image content for the first frame based on the first orientation;
process the first frame based on the received image content for the first frame;
subsequent to processing the first frame, output information indicative of a second orientation of the display device;
receive image content for the second frame based on the second orientation;
render the second frame based on the received image content for the second frame;
output information indicative of a third orientation of the display device;
receive image content for the third frame based on the third orientation;
process the third frame based on the received image content for the third frame;
subsequent to processing the third frame, output information indicative of a fourth orientation of the display device;
receive image content for the fourth frame based on the fourth orientation; and
render the fourth frame based on the received image content for the fourth frame.
